(19) United States
(12) Patent Application Publication
(10) Pub. No.: US 2023/0305683 A1
(43) Pub. Date: Sep. 28, 2023

(54) EXTRUSION MOLDING MACHINE OPERATION PANEL

(71) Applicant: Fanuc Corporation, Yamanashi (JP)

(72) Inventors: Tatsuhiro UCHIYAMA, Yamanashi-ken (JP); Junpei MARUYAMA, Yamanashi-ken (JP)

(21) Appl. No.: 18/019,624

(22) PCT Filed: Jul. 29, 2021
(86) PCT No.: PCT/JP2021/028007

§ 371 Date: Feb. 3, 2023

(30) Foreign Application Priority Data
Aug. 4, 2020 (JP) 2020-132086

(51) Int. Cl. G06F 3/04842; G06F 3/04886; G06F 3/0481; B29C 45/17

(52) U.S. Cl. CPC G06F 3/04842; G06F 3/04886; G06F 3/0481; B29C 45/1774

(57) ABSTRACT

An operation panel of an extrusion molding machine includes a display unit that displays a target selection button and an operation start button; a touch panel that detects a touched location on an operator's display screen, and an operation recognition unit that, if the operation start button has been touched while the target selection button—is being touched, recognizes that an operation start instruction for a drive target has been given.

### TECHNICAL FIELD

The present invention relates to an operation panel for an injection molding machine (extrusion molding machine operation panel).

### BACKGROUND ART

In the field of injection molding machines, a touch-operation type of operation panel is known (for example, see JP H07-004845 B).

### SUMMARY OF THE INVENTION

Cases occur in which a touch-operation type of operation panel may recognize an operation that was not intended by an operator. The causes thereof may include, for example, an erroneous operation by the operator, and an erroneous operation of the touch panel (touch screen). In such a case, the object to be driven by the injection molding machine performs an operation that is not intended by the operator.

The present invention has the object of solving the aforementioned problem.

An aspect of the present invention is characterized by an operation panel for an injection molding machine, the operation panel for the injection molding machine including a display unit including a display screen, and configured to display on the display screen a target selection button configured to select an object to be driven of the injection molding machine, and an operation start button configured to initiate an operation of the object to be driven, a touch panel provided on the display screen, and configured to detect a touch position of an operator on the display screen, and an operation recognition unit configured to, in a case that the operation start button is touched in a state in which the target selection button is touched and touch of the target selection button is maintained, recognize that an instruction has been issued to initiate the operation of the object to be driven that has been selected by the target selection button.

According to the present invention, any concern over an erroneous operation of the object to be driven is reduced.

### BRIEF DESCRIPTION OF THE DRAWINGS

FIG. 1 is a configuration diagram of an injection molding machine to which an operation panel according to an embodiment is applied;

FIG. 2 is a front view of the operation panel according to the embodiment;

FIG. 3 is a functional schematic configuration diagram of the operation panel;

FIG. 4 is a flowchart illustrating the process flow of a recognition process by an operation recognition unit for recognizing an instruction to initiate an operation of an object to be driven;

FIG. 5 is a diagram illustrating a display screen of the operation panel applied to an operation of an ejector device;

FIG. 6 is a schematic configuration diagram of a core driving device;

FIG. 7 is a diagram illustrating a display screen of the operation panel applied to an operation of the core;

FIG. 8 is a schematic configuration diagram of a mold clamping unit;

FIG. 9 is a diagram illustrating a display screen of the operation panel applied to an operation of the mold clamping unit;

FIG. 10 is a schematic configuration diagram of an injection device;

FIG. 11 is a diagram illustrating a display screen of the operation panel applied to an operation for forward movement of a screw;

FIG. 12 is a diagram illustrating a display screen of the operation panel applied to an operation for rotating of a screw;

FIG. 13 is a schematic diagram illustrating a mold rotating device;

FIG. 14 is a diagram illustrating a display screen of the operation panel applied to an operation for rotating of a mold;

FIG. 15 is a schematic configuration diagram of a robot provided in the injection molding machine;

FIG. 16 is a diagram illustrating a display screen of the operation panel applied to an operation for the robot;

FIG. 17 is a flowchart illustrating the process flow of a recognition process by the operation recognition unit according to Exemplary Modification 2 for recognizing an instruction to start the operation of the object to be driven and an instruction to stop the operation thereof;

FIG. 18A is a first diagram for explaining a selection procedure for selecting the object to be driven in Exemplary Modification 2;

FIG. 18B is a second diagram for explaining a selection procedure for selecting the object to be driven in Exemplary Modification 2;

FIG. 19 is a diagram illustrating a display screen of the operation panel according to Exemplary Modification 5; and

FIG. 20 is a diagram illustrating a display screen of the operation panel according to Exemplary Modification 7.

### DETAILED DESCRIPTION OF THE INVENTION

### Embodiment

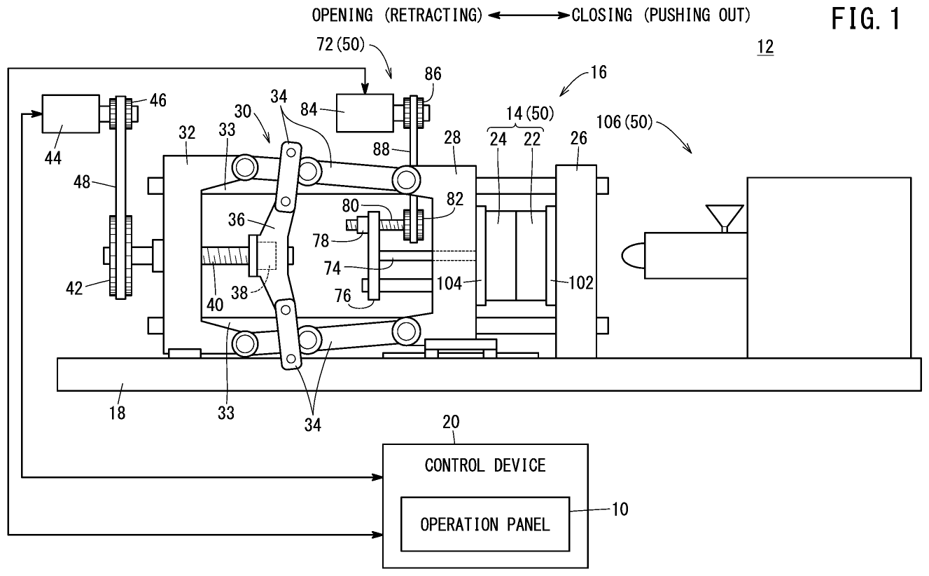

FIG. 1 is a configuration diagram of an injection molding machine 12 to which an operation panel 10 according to an embodiment is applied. An opening direction and a closing direction indicated by the arrows in FIG. 1 are directions that are opposite to each other. According to the present embodiment, both the opening direction and the closing direction are parallel to the horizontal direction.

First, referring to FIG. 1, a description will be presented concerning an injection molding machine 12 to which the operation panel 10 of the present embodiment is applied. As shown in FIG. 1, the injection molding machine 12 is equipped with a mold 14, a mold clamping device 16, a machine base 18, and a control device 20.

The mold 14 includes a fixed mold 22 and a movable mold 24. The fixed mold 22 is installed on the machine base 18 in a manner so as not to move in the opening/closing direction. The movable mold 24 is installed on the machine base 18 so as to be capable of moving along the opening/closing direction.

The mold clamping device 16 is a device that moves the movable mold 24 along the opening/closing direction. The mold clamping device 16 is installed on the machine base 18. The mold clamping device 16 comprises a stationary platen 26 and a movable platen 28. The stationary platen 26 supports the fixed mold 22 via a mounting plate 102. The movable platen 28 supports the movable mold 24 via a mounting plate 104. Further, the mold clamping device 16 is further equipped with a mold opening/closing mechanism 30, a rear platen 32, and a plurality of tie bars 33. The mold opening/closing mechanism 30 moves the movable platen 28 along the opening/closing direction. The movable mold 24 moves together with the movable platen 28. The rear platen 32 is installed at a position separated away from the movable platen 28 in the opening direction. The plurality of tie bars 33 connect the stationary platen 26 and the rear platen 32.

In the present embodiment, the mold opening/closing mechanism 30 is a toggle type of opening/closing mechanism. More specifically, the mold opening/closing mechanism 30 includes a crosshead 36, a nut 38, and a ball screw 40. The crosshead 36 is connected to the movable platen 28 via a toggle link 34. Further, the nut 38 is connected to the crosshead 36. The nut 38 is screw-engaged with the ball screw 40. An axial direction of the ball screw 40 is the opening/closing direction. The ball screw 40 is rotatably supported by the rear platen 32. Further, the mold opening/closing mechanism 30 further comprises a driven pulley 42, a motor 44, a drive pulley 46, and a belt 48. The driven pulley 42 rotates integrally with the ball screw 40. The drive pulley 46 rotates integrally with a rotary axis (a shaft) of the motor 44. The belt 48 transmits a rotational force from the drive pulley 46 to the driven pulley 42. Moreover, the motor 44 is driven by a non-illustrated amplifier. The amplifier is connected to the control device 20. The amplifier is controlled by the control device 20. Accordingly, the motor 44 is substantially controlled by the control device 20.

The motor 44 causes the ball screw 40 to rotate. When the ball screw 40 rotates, the crosshead 36 and the nut 38 move along the opening/closing direction. When the crosshead 36 moves along the opening/closing direction, the movable platen 28 and the movable mold 24 move integrally along the opening/closing direction. By moving in the closing direction, the movable mold 24 comes into contact with the fixed mold 22 (mold closing). When mold closing is performed, a cavity is formed in the mold 14. Further, by moving in the opening direction, the movable mold 24 separates away from the fixed mold 22 (mold opening).

The control device 20 is an electronic device (computer) that governs the control of the injection molding machine 12 as a whole. The control device 20 includes a processor and a memory, neither of which are shown. A predetermined program is stored in the memory of the control device 20. The processor of the control device 20 controls the injection molding machine 12 by executing the predetermined program.

The operation panel 10 is provided on the control device 20. The operator uses the operation panel 10 in order to issue instructions (instructions regarding operations of an object to be driven 50) to the control device 20.

The object to be driven 50 is an element that performs a predetermined operation in the injection molding machine 12. For example, the aforementioned mold 14 (more precisely, the movable mold 24 of the mold 14) performs mold opening and mold closing in the injection molding machine 12. Accordingly, the mold 14 is one specific example of the object to be driven 50. In this case, the operation panel 10 is used by the operator in order to issue instructions to the control device 20 to initiate mold opening and mold closing. In the following description, a description will be presented of an example of the operation panel 10 in order for the operator to issue each of a mold opening (initiation/stopping) and a mold closing (initiation/stopping) instruction, with the mold 14 serving as the object to be driven 50.

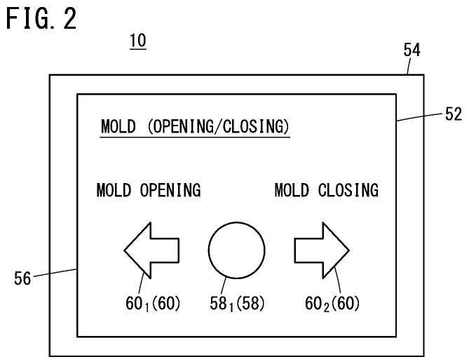

FIG. 2 is a front view of the operation panel 10 according to the embodiment.

As shown in FIG. 2, the operation panel 10 is equipped with a display unit 54 and a touch panel (touch screen) 56. The display unit 54 includes a display screen 52. The display screen 52, for example, is a liquid crystal screen. However, the material of the display screen 52 is not limited to being a liquid crystal. For example, the material of the display screen 52 may be an organic EL (OEL: Organic Electro-Luminescence) material. Moreover, the user interface (UI: User Interface) displayed on the display screen 52 of FIG. 2 is shown as an example for the purpose of describing the present embodiment in as simple a manner as possible. The UI of the operation panel 10 is not limited to that shown in FIG. 2, and a plurality of buttons other than the buttons shown in FIG. 2 may be displayed on the display screen 52.

A target selection button 58 and operation start buttons 60 are displayed on the display screen 52. Both the target selection button 58 and the operation start buttons 60 are displayed by means of a process performed by a display control unit 66. A detailed description of the display control unit 66 will be presented later. The target selection button 58 is a virtual button for selecting the object to be driven 50 of the injection molding machine 12. A mold button 58₁ shown in FIG. 2 is a specific example of the target selection button 58 to select the mold 14 as the object to be driven 50. The operation start buttons 60 are virtual buttons for initiating operations of the object to be driven 50. A mold opening button 60₁ shown in FIG. 2 is a specific example of an operation start button 60 that causes the mold 14 to start opening. A mold closing button 60₂ shown in FIG. 2 is a specific example of an operation start button 60 that causes the mold 14 to start closing.

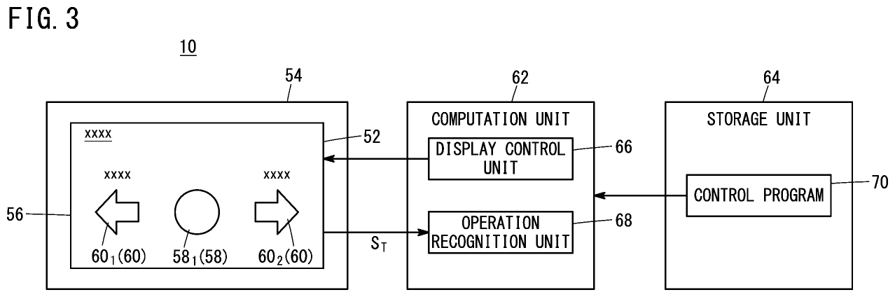

The touch panel 56 is an electronic component configured to, when the operator has touched the display screen 52, detect the touch position. At the time when the operator has touched the display screen 52, the touch panel 56 inputs a signal (a position signal S_{T} shown in FIG. 3) corresponding to the touch position thereof to an operation recognition unit 68. Details concerning the operation recognition unit 68 will be described later.

FIG. 3 is a functional schematic configuration diagram of the operation panel 10.

As shown in FIG. 3, the operation panel 10 is further equipped with a computation unit 62 and a storage unit 64. The computation unit 62 includes a processor, for example, such as a CPU (Central Processing Unit) or a GPU (Graphics Processing Unit) or the like. The storage unit 64 is constituted by a memory, for example, such as a RAM (Random Access Memory) or a ROM (Read Only Memory) or the like. It should be noted that the computation unit 62 may also include a non-illustrated processor of the above-described control device 20. Further, the storage unit 64 may also include a non-illustrated memory (not shown) of the above-described control device 20.

The computation unit 62 includes the display control unit 66 and the operation recognition unit 68. A control program 70 is stored in the storage unit 64. The control program 70 is a program for realizing control functions of the operation panel 10. By executing the control program 70, the computation unit 62 implements each of the display control unit 66 and the operation recognition unit 68.

The display control unit 66 causes the display screen 52 to display each of the target selection button 58 and the operation start buttons 60. If the object to be driven 50 can move in a plurality of directions of movement, the display control unit 66 causes the display screen 52 to display a plurality of the operation start buttons 60 corresponding to the plurality of directions of movement. Consequently, for example, the mold button 58₁, the mold opening button 60₁, and the mold closing button 60₂ illustrated in FIG. 2 are displayed on the display screen 52.

On the display screen 52, it is preferable that the directions from the target selection button 58 to the operation start buttons 60 coincide with the directions of movement of the object to be driven 50. In accordance with this feature, it becomes easier for the operator to understand the directions of movement of the object to be driven 50 that can be instructed by the operation start buttons 60. For example, if the opening direction is a leftward direction when viewed from the position where the operation panel 10 is installed, the display control unit 66 causes the mold opening button 60₁ to be displayed to the left of the mold button 58₁ on the display screen 52. Similarly, if the closing direction is a rightward direction when viewed from the position where the operation panel 10 is installed, the display control unit 66 causes the mold closing button 60₂ to be displayed to the right of the mold button 58₁ on the display screen 52. If displayed in this manner, it becomes easier for the operator to intuitively understand, for example, that the mold opening button 60₁ is a button to be touched when the movable mold 24 is to be moved in the opening direction (when opening of the mold is instructed).

The shape (icon) of the operation start buttons 60 is preferably a shape that points in the direction of movement. The shape that points in the direction of movement, for example, is an arrow shape. For example, in the example illustrated in FIG. 2, the mold opening button 60₁ is displayed with an arrow icon pointing in the opening direction. Further, in the example illustrated in FIG. 2, the mold closing button 60₂ is displayed with an arrow icon pointing in the closing direction.

A position signal S_{T} is input to the operation recognition unit 68 from the touch panel 56. Based on the position signal S_{T}, the operation recognition unit 68 recognizes what location on the display screen 52 has been touched. For example, in the case that the position signal S_{T} indicates a region where the mold button 58₁ is displayed, the operation recognition unit 68 recognizes that the mold button 58₁ has been touched.

Further, in a state in which the target selection button 58 has been touched, in the case that the operation start buttons 60 are touched, the operation recognition unit 68 recognizes that an instruction has been issued to initiate the operation of the object to be driven 50 that was selected by the target selection button 58. Concerning this feature, a detailed description thereof will be presented below.

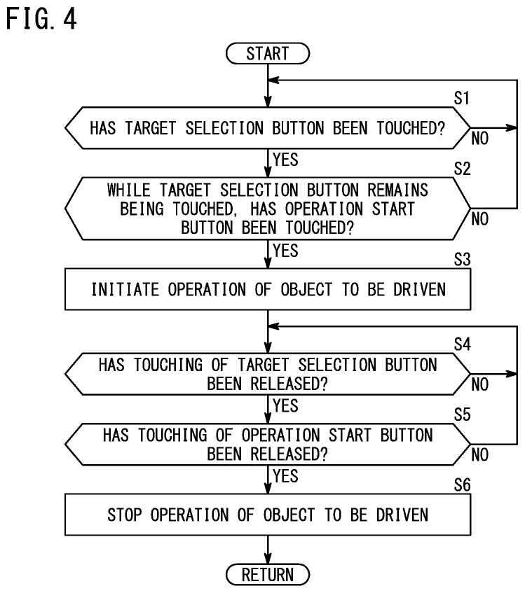

FIG. 4 is a flowchart illustrating the process flow of a recognition process by the operation recognition unit 68 for recognizing an instruction to initiate an operation of an object to be driven 50.

If the target selection button 58 is not touched (step S1: NO), the operation recognition unit 68 does not recognize that the start of operation of the object to be driven 50 has been instructed, regardless of whether or not touching of the operation start buttons 60 is occurring. For example, in the example shown in FIG. 2, even if the mold opening button 60₁ is touched in a state in which the mold button 58₁ is not being touched, the operation recognition unit 68 does not recognize that opening of the mold has been instructed. Further, for example, even if the mold closing button 60₂ is touched in a state in which the mold button 58₁ is not being touched, the operation recognition unit 68 does not recognize that closing of the mold 14 has been instructed.

In the case that the target selection button 58 remains being touched (step S1: YES), and the operation start buttons 60 are touched (step S2: YES), the operation recognition unit 68 recognizes that an instruction has been issued to initiate the operation of the object to be driven 50 that was selected by the target selection button 58 (step S3). For example, in the example shown in FIG. 2, when the mold button 58₁ is touched, and in a state in which touching thereof is maintained, then when the mold opening button 60₁ is touched, the operation recognition unit 68 recognizes that an instruction has been issued to initiate opening of the mold. As another example, for example, when the mold button 58₁ is touched, and in a state in which touching thereof is maintained, then when the mold closing button 60₂ is touched, the operation recognition unit 68 recognizes that an instruction has been issued to initiate closing of the mold.

According to the above-described recognition method, any concern that the mold 14, which serves as the object to be driven 50, may initiate an opening or closing operation contrary to the intentions of the operator is reduced. More specifically, when the operator issues an instruction to open or close the mold 14, after having touched the mold button 58₁, and while touching thereof is maintained, the operator further touches the mold opening button 60₁ or the mold closing button 60₂. In this manner, the recognition method requires a plurality of operation steps at the time when the operator issues the instruction to open or close the mold 14. Consequently, it becomes less likely for the operation recognition unit 68 to recognize an inadvertent contact (touching) of the operator on the display screen 52 as an instruction to initiate an operation. Further, it is possible to reduce any concern that the operation recognition unit 68 may erroneously recognize that an instruction has been issued to open or close the mold 14 due to an erroneous detection of the touch panel 56.

When the operation recognition unit 68 recognizes that an instruction has been issued to initiate the operation of the mold 14, the operation recognition unit 68 outputs a signal indicating that an instruction to open or close the mold 14 has been issued, to the control device 20. Consequently, the control device 20 controls the amplifier for driving the motor 44, and thereby can cause the mold 14 to be opened or closed as instructed by the operator.

Further, in the case that touching of both of the target selection button 58 and the operation start buttons 60 are released after having recognized that an instruction has been issued to initiate the operation of the object to be driven 50, the operation recognition unit 68 recognizes that an instruction has been issued to stop the operation of the object to be driven 50. A specific description concerning this feature will be presented hereinafter with further reference to FIG. 4.

During a period in which touching of either one of the target selection button 58 or the operation start buttons 60 is maintained after having recognized that an instruction has been issued to initiate the operation of the object to be driven 50, the operation recognition unit 68 does not recognize that an instruction has been issued to stop the operation of the object to be driven 50. More specifically, unless the touching of the target selection button 58 is released (step S4: NO), the operation recognition unit 68 does not recognize that an instruction has been issued to stop the operation of the object to be driven 50. Further, even if the touching of the target selection button 58 is released, unless the touching of the operation start buttons 60 is also released (step S5: NO), the operation recognition unit 68 does not recognize that an instruction has been issued to stop the operation of the object to be driven 50. For example, in the example shown in FIG. 2, after it has been recognized that an instruction to initiate the mold opening has been issued, then from among the mold button 58₁ and the mold opening button 60₁, in the case that touching of only the mold button 58₁ is released, the operation recognition unit 68 does not recognize that an instruction has been issued to stop opening of the mold. Similarly, after it has been recognized that an instruction to initiate the mold opening has been issued, then from among the mold button 58₁ and the mold opening button 60₁, if touching of only the mold opening button 60₁ is released, the operation recognition unit 68 does not recognize that an instruction has been issued to stop opening of the mold.

In the case that touching of both of the target selection button 58 and the operation start buttons 60 are released after having recognized that an instruction has been issued to initiate the operation of the object to be driven 50 (step S4: YES, step S5: YES), the operation recognition unit 68 recognizes that an instruction has been issued to stop the operation of the object to be driven 50 (step S6). For example, in the example shown in FIG. 2, when touching of both the mold button 58₁ and the mold opening button 60₁ is released after it has been recognized that an instruction to initiate the mold opening has been issued, the operation recognition unit 68 recognizes that an instruction has been issued to stop opening of the mold. Thereafter, the operation recognition unit 68 outputs, to the control device 20, a signal indicating that an instruction has been issued to cause the object to be driven 50 to stop. Upon receiving this signal, the control device 20 causes the object to be driven 50 to stop.

According to the above-described recognition method, any concern that the mold 14, which serves as the object to be driven 50, may stop the opening or closing operation contrary to the intentions of the operator is reduced. More specifically, in order to issue the instruction to stop the opening operation of the mold 14, it is necessary for the operator to release both touching of the mold button 58₁ and touching of the mold opening button 60₁. Consequently, for example, even if touching of either one of the mold button 58₁ or the mold opening button 60₁ is released contrary to the intentions of the operator (for example, due to improper positioning of the fingers or the like), the operation to open the mold is not stopped. Further, for example, in the case that the touch panel 56 is not working properly, it is possible to reduce any concern that the operation recognition unit 68 may erroneously recognize that an instruction has been issued to stop opening of the mold although the operator continues to carry out touching thereon.

The above is an example of the overall configuration of the operation panel 10 according to the present embodiment. However, the object to be driven 50 is not limited to being the mold 14. In the following description, several specific examples of the object to be driven 50 will be presented. Further, exemplary applications of the operation panel 10 in the case of operating the object to be driven 50 which is presented as the examples will be described.

The specific examples of the object to be driven 50 that is provided in the mold clamping device 16 will be presented in Exemplary Application 1 to Exemplary Application 3 described below.

### (Exemplary Application 1)

As shown in FIG. 1, the mold clamping device 16 described above further comprises an ejector device 72. The ejector device 72 is a device that is driven in order to remove a molded product from the movable mold 24. The ejector device 72 is equipped with an ejector pin 74, an ejector plate 76, a nut 78, and a ball screw 80. The ejector pin 74 is a pin (a bar-shaped member) for ejecting the molded product. The ejector plate 76 supports the ejector pin 74. The nut 78 is connected to the ejector plate 76. The nut 78 is screw-engaged with the ball screw 80. An axial direction of the ball screw 80 is parallel to a pushing out direction of the ejector pin 74 toward the mold 14 in FIG. 1 (It can also be said that it is parallel to a retracting direction opposite to the pushing out direction). Further, the ejector device 72 further comprises a driven pulley 82, a motor 84, a drive pulley 86, and a belt 88. The driven pulley 82 rotates integrally with the ball screw 80. The drive pulley 86 rotates integrally with a rotary axis (a shaft) of the motor 84. The belt 88 transmits a rotational force from the drive pulley 86 to the driven pulley 82.

The ejector device 72 causes the ball screw 80 to rotate by driving the motor 84. Further, the ejector device 72 causes the ejector plate 76 and the ejector pin 74 to move by rotating the ball screw 80. By switching the directions of rotation of the rotary axis of the motor 84, the direction of movement of the ejector pin 74 can be switched between the pushing out direction and the retracting direction. By being moved in the pushing out direction, the ejector pin 74 pushes out the molded product from the movable mold 24. Consequently, the molded product is taken out from the movable mold 24. After the molded product has been pushed out from the movable mold 24, the ejector pin 74 returns to its original position by moving in the retracting direction. The motor 84 is driven by a non-illustrated amplifier. The amplifier is connected to the control device 20. The amplifier is controlled by the control device 20. Accordingly, the motor 84 is substantially controlled by the control device 20.

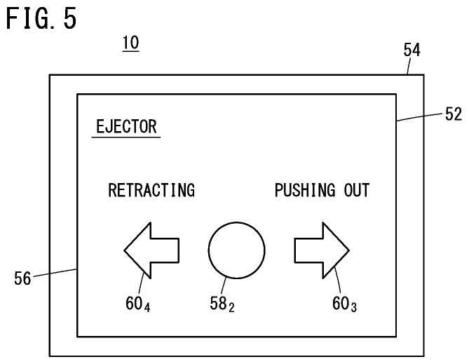

FIG. 5 is a diagram illustrating a display screen 52 of the operation panel 10 applied to an operation of the ejector device 72.

The ejector device 72 (the ejector pin 74), which performs each of the pushing out operation and the retracting operation in the manner described above, is one specific example of the object to be driven 50. The operation panel 10 may be adapted in order to operate the ejector device 72. Specifically, for example, the operation panel 10 may be applied in order to instruct each of the pushing out and the retracting of the ejector pin 74. In this case, the UI displayed on the display screen 52 is as shown in FIG. 5, for example. An ejector button 58₂, a pushing out button 60₃, and a retracting button 60₄ are displayed on the display screen 52 as shown in FIG. 5. The ejector button 58₂ is a target selection button 58 for the purpose of selecting the ejector device 72 (the ejector pin 74) as the object to be driven 50. The pushing out button 60₃ is an operation start button 60 for the purpose of instructing that the pushing out operation of the ejector pin 74 be initiated. The retracting button 60₄ is an operation start button 60 for the purpose of instructing that the retracting operation of the ejector pin 74 be initiated. It is preferable that the retracting button 60₄ be displayed at a location, on the display screen 52, that is displaced in the opening direction from the ejector button 58₂. Further, it is preferable that the pushing out button 60₃ be displayed in a region, on the display screen 52, that is displaced in the closing direction from the ejector button 58₂.

According to the present exemplary application, while touching of the ejector button 58₂ is maintained, the operator touches the pushing out button 60₃. Consequently, an instruction to push out the ejector pin 74 is issued to the control device 20. Further, while touching of the ejector button 58₂ is maintained, the operator touches the retracting button 60₄. Consequently, an instruction to retract the ejector pin 74 is issued to the control device 20.

### (Exemplary Application 2)

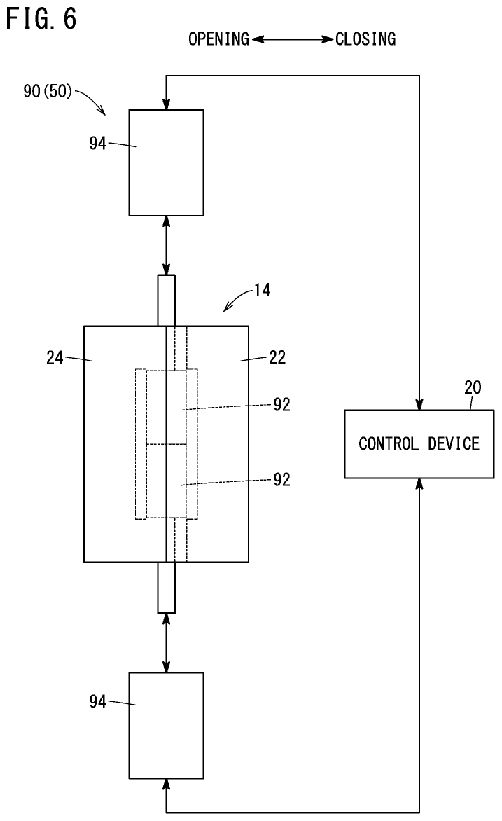

FIG. 6 is a schematic configuration diagram of a core driving device 90.

Although illustration thereof is omitted in FIG. 1, the mold clamping device 16 further comprises the core driving device 90 as shown in FIG. 6. The core driving device 90 is equipped with a core 92 and a hydraulic cylinder 94. The hydraulic cylinder 94 is an actuator that causes the core 92 to move into and out of the cavity of the mold 14. The hydraulic cylinder 94 causes the core 92 to move along the vertical direction of the sheet surface shown in the example of FIG. 6. The hydraulic cylinder 94 is controlled by the control device 20.

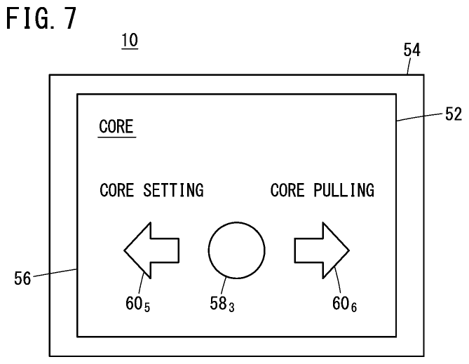

FIG. 7 is a diagram illustrating a display screen 52 of the operation panel 10 applied to an operation of the core 92.

The core driving device 90 (and the core 92) described above is one specific example of the object to be driven 50. The operation panel 10 may be adapted in order to operate the core driving device 90. Specifically, for example, the operation panel 10 may be applied in order to operate the movement of the core 92 into and out of the cavity. In this case, the UI displayed on the display screen 52 is as shown in FIG. 7, for example. A core button 58₃, a core setting button 60₅, and a core pulling button 60₆ are displayed on the display screen 52 shown in FIG. 7. The core button 58₃ is a target selection button 58 for the purpose of selecting the core driving device 90 (the core 92) as the object to be driven 50. The core setting button 60₅ is an operation start button 60 for the purpose of issuing an instruction to initiate the movement of the core 92 into the cavity (core setting). The core pulling button 60₆ is an operation start button 60 for the purpose of issuing an instruction to initiate the movement of the core 92 out of the cavity (core pulling).

According to the present exemplary application, the operator touches the core setting button 60₅ while touching of the core button 58₃ is maintained. Consequently, the control device 20 is instructed to initiate the core setting. Further, the operator touches the core button 58₃, and while touching thereof is maintained, the operator touches the core pulling button 60₆. Consequently, the control device 20 is instructed to initiate the core pulling.

Moreover, it should be noted that the actuator that causes the core 92 to move is not limited to being the hydraulic cylinder 94. For example, the actuator that causes the core 92 to move may be a motor.

### (Exemplary Application 3)

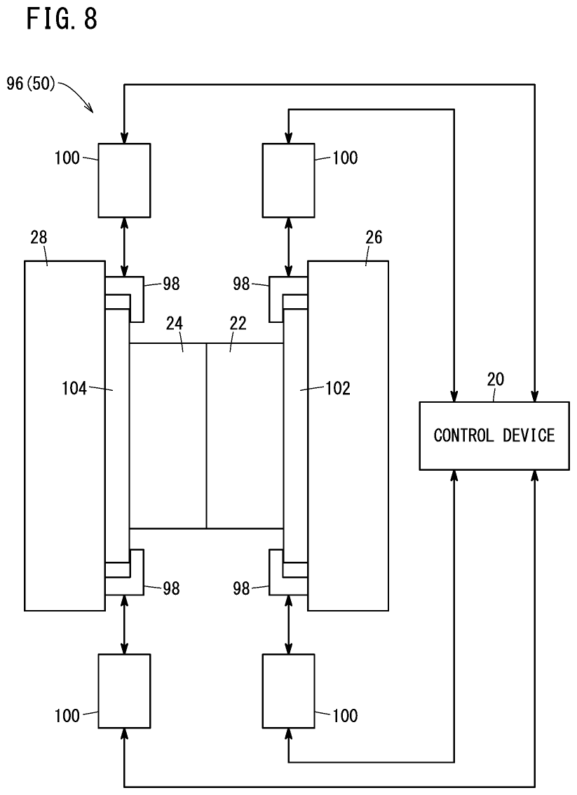

FIG. 8 is a schematic configuration diagram of a mold clamping unit 96.

Although illustration thereof is omitted in FIG. 1, the mold clamping device 16 further comprises the mold clamping unit 96 as shown in FIG. 8. The mold clamping unit 96 is a hydraulic clamping unit in this example. More specifically, the mold clamping unit 96 is equipped with clampers 98 and a hydraulic cylinder 100. Among the clampers 98, there are included a clamper 98 that is installed on the stationary platen 26, and a clamper 98 that is installed on the movable platen 28. The hydraulic cylinder 100 causes the clampers 98 to be driven. The clamper 98 installed on the stationary platen 26 engages (clamps) the mounting plate 102 on which the fixed mold 22 is installed. Consequently, the fixed mold 22 is fixed to the stationary platen 26. The clamper 98 installed on the movable platen 28 engages (clamps) the mounting plate 104 on which the movable mold 24 is installed. Consequently, the movable mold 24 is fixed to the movable platen 28. The hydraulic cylinder 100 switches between engagement and releasing (unclamping) of the clampers 98.

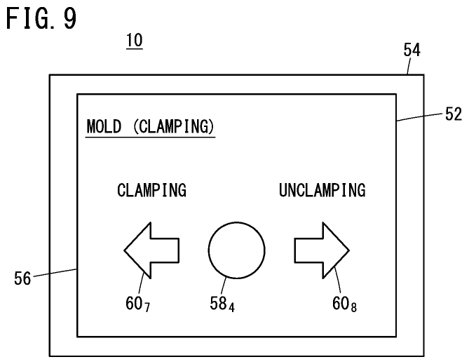

FIG. 9 is a diagram illustrating a display screen 52 of the operation panel 10 applied to an operation of the mold clamping unit 96.

The mold clamping unit 96 (the clampers 98) is one specific example of the object to be driven 50. The operation panel 10 may be applied in order to operate the mold clamping unit 96. Specifically, for example, the operation panel 10 may be applied in order to issue an instruction to switch between clamping and unclamping of the mold 14 by the mold clamping unit 96. In this case, the UI displayed on the display screen 52 is as shown in FIG. 9, for example. A clamper button 58₄, a clamping button 60₇, and an unclamping button 60₈ are displayed on the display screen 52 as shown in FIG. 9. The clamper button 58₄ is a target selection button 58 for the purpose of selecting the mold clamping unit 96 (the clampers 98) as the object to be driven 50. The clamping button 60₇ is an operation start button 60 for the purpose of instructing clamping of the mold 14. The unclamping button 60₈ is an operation start button 60 for the purpose of instructing unclamping of the mold 14.

According to the present exemplary application, while touching of the clamper button 58₄ is maintained, the operator touches the clamping button 60₇. Consequently, an instruction to clamp the mold 14 is issued to the control device 20. Further, while touching of the clamper button 58₄ is maintained, the operator touches the unclamping button 60₈. Consequently, an instruction to unclamp the mold 14 is issued to the control device 20.

Exemplary Application 1 to Exemplary Application 3, which are specific examples of the object to be driven 50 that is provided in the mold clamping device 16, have been described above. Subsequently, specific examples of the object to be driven 50 that is provided in an injection device 106 will be presented in Exemplary Application 4 and Exemplary Application 5 described below.

### (Exemplary Application 4)

As shown in FIG. 1, the injection molding machine 12 further comprises the injection device 106. The injection device 106 is a device that melts a material (a resin material) for a molded product, and injects the material into the mold 14.

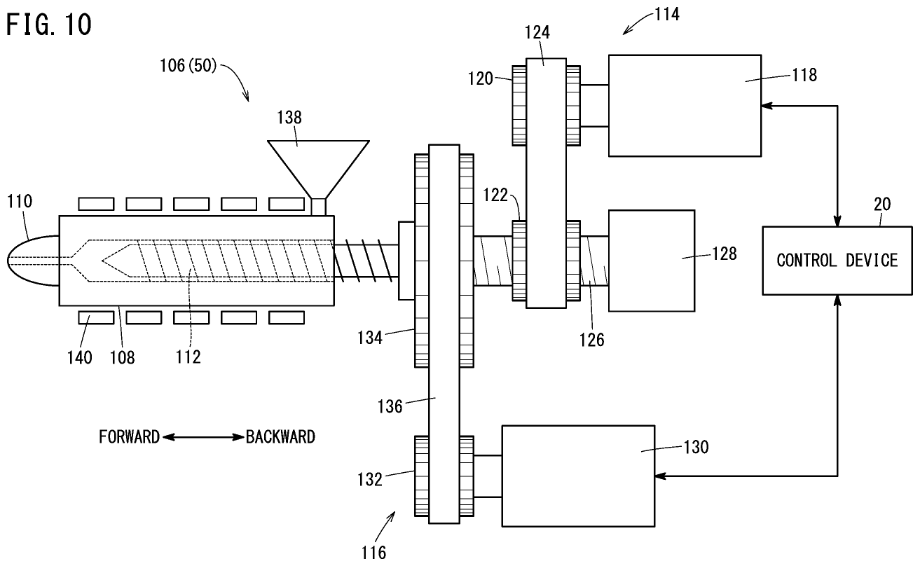

FIG. 10 is a schematic configuration diagram of the injection device 106. A forward-backward direction of the injection device 106 shown in FIG. 10 is parallel to the opening/closing direction of the mold 14. Although illustration thereof is omitted in FIG. 10, the mold 14 and the mold clamping device 16 are installed at positions more forward than the injection device 106.

As shown in greater detail in FIG. 10, the injection device 106 is equipped with a cylinder 108, a nozzle 110, and a screw 112. The cylinder 108 is a tubular member. The nozzle 110 is installed on a distal end in the forward direction of the cylinder 108. The screw 112 is installed inside the cylinder 108. An axial direction of the screw 112 is parallel to the forward-backward direction.

The injection device 106 is further equipped with a first drive device 114 and a second drive device 116 that cause the screw 112 to be rotated inside the cylinder 108. The first drive device 114 is a device that serves to cause the screw 112 to move inside the cylinder 108. The first drive device 114 is equipped with a motor 118, a drive pulley 120, a driven pulley 122, and a belt 124. The drive pulley 120 rotates integrally with a rotary axis (a shaft) of the motor 118. The driven pulley 122 rotates integrally with the screw 112. The belt 124 transmits a rotational force from the drive pulley 120 to the driven pulley 122. Further, the first drive device 114 is further equipped with a ball screw 126 and a nut 128. The ball screw 126 extends in the axial direction of the screw 112. The nut 128 is screw-engaged with the ball screw 126. The first drive device 114 causes the motor 118 to be driven, and thereby causes the screw 112 to be moved in the forward-backward direction. The motor 118 is driven by a non-illustrated amplifier. The amplifier is connected to the control device 20. The amplifier is controlled by the control device 20. Accordingly, the motor 118 is substantially controlled by the control device 20.

The second drive device 116 is a device that serves to cause the screw 112 to rotate inside the cylinder 108. The second drive device 116 is equipped with a motor 130, a drive pulley 132, a driven pulley 134, and a belt 136. The drive pulley 132 rotates integrally with a rotary axis (a shaft) of the motor 130. The driven pulley 134 rotates integrally with the screw 112. The belt 136 transmits a rotational force from the drive pulley 132 to the driven pulley 134. The second drive device 116 rotates the screw 112 in accordance with the driving of the motor 130. The motor 130 is driven by a non-illustrated amplifier. The amplifier is connected to the control device 20. The amplifier is controlled by the control device 20. Accordingly, the motor 130 is substantially controlled by the control device 20.

The injection device 106 is further equipped with a hopper 138 and a heater 140. A resin material is stored in the hopper 138. The resin material is introduced into the cylinder 108 from the hopper 138. The heater 140 heats and melts the resin material that has been introduced into the cylinder 108.

The resin material stored in the hopper 138, for example, is in the form of a granular solid (pellets). Such pellets are changed from a solid into a plastic molten resin by the heat of the heater 140, and shear heat generated by the rotation of the screw 112. The screw 112 rotates along a predetermined direction of rotation. Consequently, the molten resin is delivered under pressure in the forward direction (toward the nozzle 110) within the cylinder 108. Along with such delivery under pressure, the screw 112 receives a reaction force from the molten resin and thereby moves backward. After having delivered a predetermined amount of the molten resin under pressure toward the nozzle 110, the injection device 106 causes the screw 112 to move in the forward direction. Consequently, the molten resin inside the cylinder 108 is injected out of the cylinder 108 through the nozzle 110.

The injection device 106 (the screw 112) is one specific example of the object to be driven 50. The operation panel 10 may be adapted in order to operate the injection device 106. Specifically, for example, the operation panel 10 may be applied in order to issue an instruction for forward movement of the screw 112 at a time when the molten resin is injected.

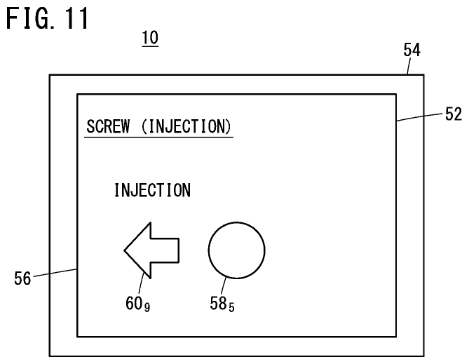

FIG. 11 is a diagram illustrating a display screen 52 of the operation panel 10 applied to an operation for forward movement of the screw 112.

In the case that the forward movement of the screw 112 is operated by the operation panel 10, the UI displayed on the display screen 52 is as shown in FIG. 11, for example. A first screwing button 58₅ and an injection button 60₉ are displayed on the display screen 52 shown in FIG. 11. The first screwing button 58₅ is a target selection button 58 for the purpose of selecting the screw 112 as the object to be driven 50. The injection button 60₉ is an operation start button 60 for the purpose of instructing that forward movement of the screw 112 be initiated at the time of injection. As noted previously, it is preferable that the injection button 60₉ is displayed on the display screen 52 at a position (to the left on the sheet surface of FIG. 11) more forward than the first screwing button 58₅.

According to the present exemplary application, while touching of the first screwing button 58₅ is maintained, the operator touches the injection button 60₉. As a result, the control device 20 is instructed to initiate forward movement (injection) of the screw 112.

### (Exemplary Application 5)

The operation panel 10 may be applied in order to issue an instruction to bring about a rotational action of the screw 112 at a time during delivery under pressure of the molten resin described in Exemplary Application 4.

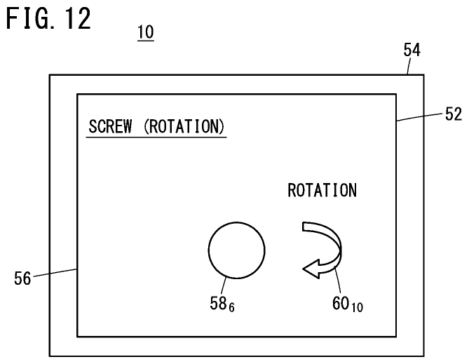

FIG. 12 is a diagram illustrating a display screen 52 of the operation panel 10 applied to a rotating operation of the screw 112.

In the case that rotation of the screw 112 is operated through the operation panel 10, the UI displayed on the display screen 52 is as shown in FIG. 12, for example. A second screwing button 58₆ and a screw rotation button 60₁₀ are displayed on the display screen 52 shown in FIG. 12. The second screwing button 58₆ is a target selection button 58 for the purpose of selecting the screw 112 as the object to be driven 50. The screw rotation button 60₁₀ is an operation start button 60 for the purpose of issuing an instruction to initiate delivery under pressure of the molten resin (rotation of the screw 112 along the predetermined direction of rotation).

The screw rotation button 60₁₀ shown in FIG. 12 has a substantially circular-arcuate arrow shape. In this manner, the shape (icon) of the operation start button 60 for issuing an instruction to rotate the object to be driven 50 preferably is of a shape that indicates that the action to be instructed is rotation. In accordance with this feature, it becomes easier for the operator to understand the content of the operation that is instructed to the control device 20 by operating the operation start button 60.

According to the present exemplary application, while touching of the second screwing button 58₆ is maintained, the operator touches the screw rotation button 60₁₀. Consequently, an instruction is issued to the control device 20 to initiate delivery under pressure (rotation of the screw 112 along the predetermined direction of rotation) of the molten resin.

Exemplary Application 4 and Exemplary Application 5, which are specific examples of the object to be driven 50 that is provided in the injection device 106, have been described above. In Exemplary Application 6 and Exemplary Application 7 described below, exemplary applications of the operation panel 10 will be described by citing specific examples of the object to be driven 50 which differ from those described above.

### (Exemplary Application 6)

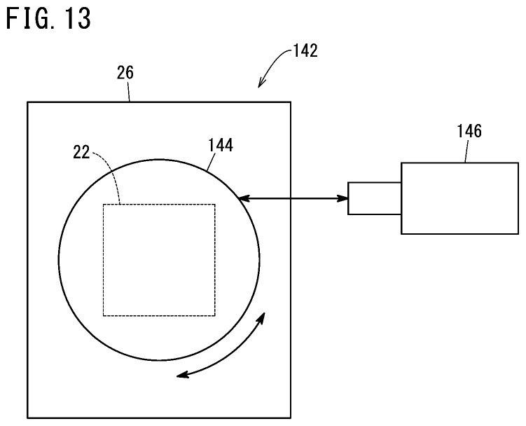

FIG. 13 is a schematic diagram illustrating a mold rotating device 142. FIG. 13 is as viewed along the opening/closing direction of the mold 14.

As shown in FIG. 13, the injection molding machine 12 may be further equipped with the mold rotating device 142. The mold rotating device 142 is a device provided in order to cause the mold 14 to rotate. For example, as shown in FIG. 13, the mold rotating device 142 comprises a rotating disk 144 and a motor 146. The rotating disk 144 is installed on the stationary platen 26. The rotating disk 144 supports the fixed mold 22 so as to be capable of rotating. The motor 146 imparts a rotational force to the rotating disk 144. Moreover, although shown in a simplified manner in FIG. 13, in actuality, a plurality of members (pulleys, gears) may be installed between the rotating disk 144 and the motor 146 in order to transmit the rotational force of the motor 146 to the rotating disk 144. The rotating disk 144 rotates in accordance with driving of the motor 146. As a result, the fixed mold 22 is rotated together with the rotating disk 144. The motor 146, for example, is a servo motor. The motor 146 is controlled by the control device 20. Moreover, it should be noted that the rotating disk 144 may be installed on the movable platen 28. In that case, instead of the fixed mold 22, the rotating disk 144 supports the movable mold 24 so as to be capable of rotating. Consequently, the movable mold 24 is rotated together with the rotating disk 144.

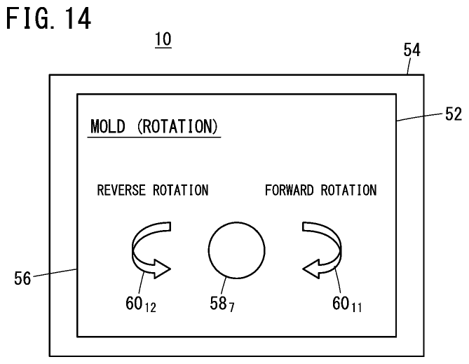

FIG. 14 is a diagram illustrating a display screen 52 of the operation panel 10 applied to a rotating operation of the mold 14.

In the injection molding machine 12 equipped with the mold rotating device 142, the mold 14 serves as the object to be driven 50 that carries out the rotating operation. In this case, the operation panel 10 may be applied in order to operate the rotation of the mold 14 (the rotating disk 144). In this case, the UI displayed on the display screen 52 is as shown in FIG. 14, for example. A mold button 58₇ is displayed on the display screen 52 shown in FIG. 14. The mold button 58₇ is a target selection button 58 for the purpose of selecting the mold 14 (the rotating disk 144) as the object to be driven 50 that is rotated. Further, a forward rotation button 60₁₁ and a reverse rotation button 60₁₂ are displayed on the display screen 52 shown in FIG. 14. The forward rotation button 60₁₁ is an operation start button 60 for the purpose of causing the mold 14 to be rotated along a forward direction of rotation. The reverse rotation button 60₁₂ is an operation start button 60 for the purpose of causing the mold 14 to be rotated along a reverse direction of rotation (a direction of rotation opposite to the forward direction of rotation). Moreover, according to the present exemplary application, from the viewpoint shown in FIG. 13, the forward direction of rotation is a clockwise direction (the reverse direction of rotation is a counterclockwise direction).

In FIG. 14, the forward rotation button 60₁₁ for the purpose of instructing clockwise rotation of the mold 14 is displayed, on the display screen 52, to the right of the mold button 58₇. In accordance with this feature, it becomes easier for the operator to intuitively understand the direction of rotation (the clockwise direction in this case) of the mold 14 that is instructed to the control device 20 by operating the forward rotation button 60₁₁. Further, in FIG. 14, the reverse rotation button 60₁₂ for the purpose of instructing counterclockwise rotation of the mold 14 is displayed, on the display screen 52, to the left of the mold button 58₇. In accordance with this feature, it becomes easier for the operator to intuitively understand the direction of rotation (the counterclockwise direction in this case) of the mold 14 that is instructed to the control device 20 by operating the reverse rotation button 60₁₂. In this manner, in the case that the object to be driven 50 is capable of rotating in a plurality of directions of rotation, it is preferable to determine the arrangement of the plurality of operation start buttons 60 depending on the plurality of directions of rotation.

According to the present exemplary application, while touching of the mold button 58₇ is maintained, the operator touches the forward rotation button 60₁₁. Consequently, an instruction to initiate rotation (clockwise rotation) of the mold 14 is issued to the control device 20. Further, while touching of the mold button 58₇ is maintained, the operator touches the reverse rotation button 60₁₂. Consequently, an instruction to initiate rotation (counterclockwise rotation) of the mold 14 is issued to the control device 20.

### (Exemplary Application 7)

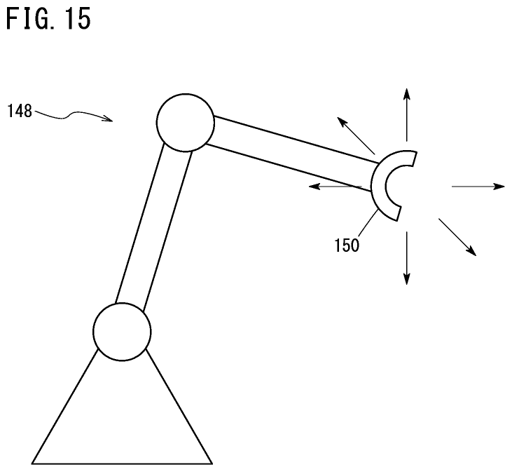

FIG. 15 is a schematic configuration diagram of a robot 148 provided in the injection molding machine 12.

The injection molding machine 12 may be further equipped with the robot 148 as shown in FIG. 15. The robot 148 comprises an arm 150. The arm 150 is driven by a plurality of non-illustrated motors. In FIG. 15, the plurality of arrows around the arm 150 indicate the directions in which the arm 150 is driven. However, the directions in which the arm 150 is driven are not limited to those directions illustrated in FIG. 15. The robot 148 is arranged, for example, in the vicinity of (on the side of) the mold 14 at a certain distance from the mold 14. The arm 150 of the robot 148 holds an insert, for example. Further, for example, the arm 150 inserts the insert into the cavity. Alternatively, the arm 150 of the robot 148 takes out the molded product from the mold 14 and places the molded product on a molded product placement site (a conveyor).

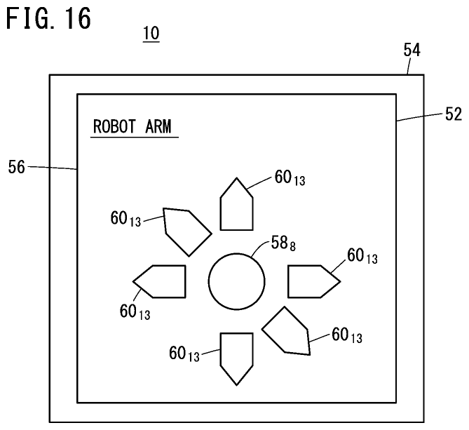

FIG. 16 is a diagram illustrating a display screen 52 of the operation panel 10 applied to an operation of the robot 148.

The operation panel 10 according to the present embodiment may be applied in order to operate the robot 148 as described above. Specifically, for example, the operation panel 10 may be applied in order to operate a movement destination of the arm 150. In this case, the UI displayed on the display screen 52 is as shown in FIG. 16, for example. A robot button 58₈ and a plurality of arm movement buttons 60₁₃ are displayed on the display screen 52 shown in FIG. 16. The robot button 58₈ is a target selection button 58 for the purpose of selecting the robot 148 (the arm 150) as the object to be driven 50. The plurality of arm movement buttons 60₁₃ are operation start buttons 60 for the purpose of instructing movement of the arm 150 along corresponding directions in which the arm 150 is driven. Each of the plurality of arm movement buttons 60₁₃ corresponds to a different driving direction. For example, the arm movement button 60₁₃ that is displayed to the right of the robot button 58₈ on the display screen 52 is an operation start button 60 for the purpose of issuing an instruction that the arm 150 be moved along the right direction on the sheet surface of FIG. 15. Further, for example, the arm movement button 60₁₃ that is displayed downwardly of the robot button 58₈ on the display screen 52 is an operation start button 60 for the purpose of issuing an instruction that the arm 150 be moved along a downward direction on the sheet surface of FIG. 15.

According to the present exemplary application, the operator touches one of the plurality of arm movement buttons 60₁₃ while touching of the robot button 58₈ is maintained. Consequently, an instruction is issued to the control device 20 to move the arm 150.

### [Exemplary Modifications]

Hereinafter, several exemplary modifications according to the embodiment will be specifically described. However, in the following description, the same names and reference numerals are applied to those elements that have already been described in the embodiment. Further, descriptions of matters that overlap with the embodiment will be omitted as appropriate.

### (Exemplary Modification 1)

In the case that touching of both of the target selection button 58 and the operation start buttons 60 are released after having recognized that an instruction has been issued to initiate the operation of the object to be driven 50, the operation recognition unit 68 according to the present embodiment recognizes that an instruction has been issued to stop the operation of the object to be driven 50. The operation recognition unit 68 is not necessarily limited to this feature. More specifically, in the case that touching of either one of the target selection button 58 and the operation start buttons 60 is released after having recognized that an instruction has been issued to initiate the operation of the object to be driven 50, the operation recognition unit 68 may recognize that an instruction has been issued to stop the operation of the object to be driven 50. In this case, when the operator desires to stop the operation of the object to be driven 50, the operator releases either one from among touching of the target selection button 58 and touching of the operation start buttons 60. In accordance with this feature, the operator is capable of easily and quickly stopping the operation of the object to be driven 50.

### (Exemplary Modification 2)

So-called sliding operations may be included in the touch operations required in order to cause the operation recognition unit 68 to recognize that the object to be driven 50 has been selected. In accordance with this feature, any concern over unintentional operation of the object to be driven 50 is further reduced. Hereinafter, such an exemplary modification will be described with reference to the drawings.

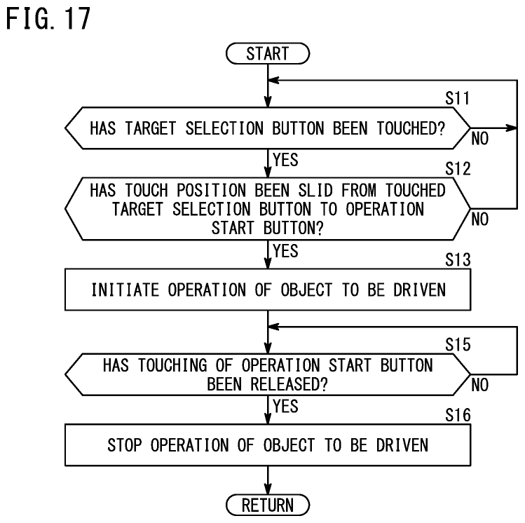

FIG. 17 is a flowchart illustrating the process flow of a recognition process by the operation recognition unit 68 according to Exemplary Modification 2 for recognizing a start instruction and a stop instruction of the object to be driven 50.

As shown in FIG. 17, after the target selection button 58 is touched (step S11: YES), and while such a state is maintained, when the touch position is slid and reaches the operation start button 60 (step S12: YES), the operation recognition unit 68 of the present exemplary modification recognizes that an instruction has been issued to initiate the operation (step S13). If the touch is released during sliding from the target selection button 58 to the operation start button 60 (step S12: NO), the operation recognition unit 68 does not recognize that an instruction has been issued to initiate the operation of the object to be driven 50. Further, in the case that touching of the operation start button 60 is released after having recognized that an instruction has been issued to initiate the operation of the object to be driven 50 (step S15: YES), the operation recognition unit 68 of the present exemplary modification recognizes that an instruction has been issued to stop the operation of the object to be driven 50 (step S16).

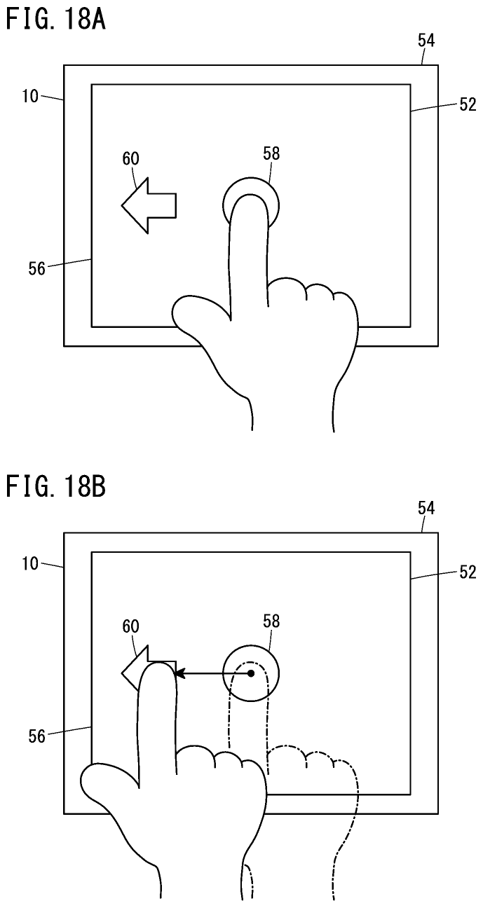

FIG. 18A is a first diagram for explaining a selection procedure for selecting the object to be driven 50 in Exemplary Modification 2. FIG. 18B is a second diagram for explaining the selection procedure for selecting the object to be driven 50 in Exemplary Modification 2.

The flow of operations illustrated in FIG. 17 will be described from the point of view of the operator. More specifically, in the present exemplary modification, in the case that the operator intends to issue an instruction to initiate the operation of the object to be driven 50, at first, as shown in FIG. 18A, the operator touches the target selection button 58. Consequently, the object to be driven 50 is selected. Next, as shown in FIG. 18B, while touching the target selection button 58, the operator slides the touch position thereof to the operation start button 60. Thus, operation of the selected object to be driven 50 is initiated. In the case that the operator desires to stop the operation of the object to be driven 50, the operator releases the touching of the operation start button 60 from the state shown in FIG. 18B. Consequently, the operation of the object to be driven 50 is quickly stopped.

According to the present exemplary modification, the object to be driven 50 does not initiate an operation unless the touch position is slid from the target selection button 58 to the operation start buttons 60. In accordance with this feature, for example, even if the operator inadvertently touches the target selection button 58 or the operation start button 60, the object to be driven 50 will not start operating. More specifically, according to the present exemplary modification, any concern that the object to be driven 50 may be stopped contrary to the intentions of the operator is further reduced in comparison with the embodiment.

Further, according to the present exemplary modification, each of the selection of the object to be driven 50, the instruction to initiate the operation of the selected object to be driven 50, and the instruction to stop the operation of the object to be driven 50 can be completed with one finger of the operator. Accordingly, the operator can issue an instruction to the object to be driven 50 with a simple operation.

### (Exemplary Modification 3)

In relation to Exemplary Modification 2, while touching of the target selection button 58 is maintained, in the case that the touch position is slid (swiped) by a predetermined distance in a predetermined sliding direction, the operation recognition unit 68 may recognize that the object to be driven 50 has been selected. In this case, while touching of the swipe destination is maintained, in the case that the operation start button 60 is touched, the operation recognition unit 68 recognizes that an instruction has been issued to initiate the operation of the object to be driven 50.

According to the present exemplary modification, it is not necessary for the touch position to be slid to the operation start button 60 after the target selection button 58 has been touched. This point differs from the second exemplary modification. However, in the present exemplary modification, for issuing the instruction to initiate the operation of the object to be driven 50, the swiping (sliding) operation is necessary. Accordingly, in the present exemplary modification as well, any concern that the object to be driven 50 may be stopped contrary to the intentions of the operator is further reduced in comparison with the embodiment.

### (Exemplary Modification 4)

As the operation start buttons 60 become capable of instructing the object to be driven 50 (the control device 20) to move faster, the display control unit 66 may cause the buttons to be displayed at positions farther away from the target selection button 58. In accordance with this feature, the operator is capable of grasping from the aforementioned distance an approximate speed of movement of the object to be driven 50 that is instructed by the operation start buttons 60.

Moreover, it is more preferable that, as the operation start buttons 60 become capable of instructing the object to be driven 50 (the control device 20) to move faster, the display control unit 66 display those buttons on the display screen 52 such that the buttons become larger (wider or longer). In accordance with this feature, it becomes easier for the operator to understand the speed of movement of the object to be driven 50 that is instructed by the operation start buttons 60.

### (Exemplary Modification 5)

A plurality of the operation start buttons 60 may be provided corresponding to a plurality of speeds of movement of the object to be driven 50. In accordance with this feature, the operator is capable of selecting the speed of movement of the object to be driven 50.

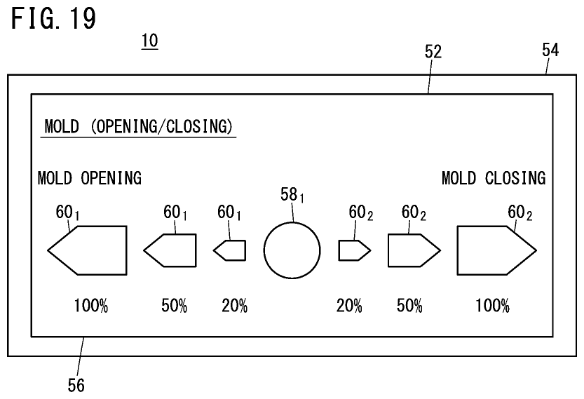

FIG. 19 is a diagram illustrating a display screen 52 of the operation panel 10 according to Exemplary Modification 5.

The present exemplary modification is more useful when combined with the aforementioned Exemplary Modification 4. Such a feature will be described with reference to FIG. 19.

On the display screen 52 shown in FIG. 19, three of the mold opening buttons 60₁ and three of the mold closing buttons 60₂ are displayed. The three mold opening buttons 60₁ designate speeds of movement of 20%, 50%, and 100% of the maximum allowable speed of the movable mold 24 at the time of mold opening, respectively. In this case, when instructing the mold opening, the operator selects the speed of movement of the movable mold 24 from among 20%, 50%, and 100% of the maximum allowable speed. The three mold closing buttons 60₂ designate speeds of movement of 20%, 50%, and 100% of the maximum allowable speed of the movable mold 24 at the time of mold closing, respectively. Accordingly, when instructing the mold closing, the operator selects the speed of movement of the movable mold 24 from among 20%, 50%, and 100% of the maximum allowable speed.

A more preferable situation results when the present exemplary modification is combined with the Exemplary Modification 4. More specifically, in the example illustrated in FIG. 19, as the mold opening buttons 60₁ instruct the object to be driven 50 (the control device 20) to move at faster speeds of movement, the mold opening buttons 60₁ are displayed at positions farther away from the mold button 58₁. Similarly, as the mold closing buttons 60₂ instruct the object to be driven 50 (the control device 20) to move at faster speeds of movement, the mold closing buttons 60₂ are displayed at positions farther away from the mold button 58₁. In accordance with this feature, for example, it becomes easy for the operator to intuitively understand which of the mold opening buttons 60₁ from among the three mold opening buttons 60₁ is the button for the purpose of instructing the object to be driven 50 (the control device 20) to undergo mold opening at the fastest speed.

Moreover, it should be noted that the present exemplary modification can be applied to a case of operating an object to be driven 50 that is capable of being operated at a plurality of speeds of movement. Accordingly, the present exemplary modification is not limited only to a case in which the opening and closing action of the mold 14 is operated. Further, according to the present exemplary modification, for purposes of illustration, the speed of movement of the mold 14 is divided into three cases of 20%, 50%, and 100% of a maximum allowable speed. However, the classification of the speeds of movement of the mold 14 (the movable mold 24) is not limited to this example.

### (Exemplary Modification 6)

As the operation start buttons 60 become capable of instructing the object to be driven 50 (the control device 20) to rotate faster, the display control unit 66 may cause the buttons to be displayed at positions farther away from the target selection button 58. In accordance with this feature, the operator is capable of grasping, from the aforementioned distance, an approximate speed of rotation of the object to be driven 50 that is instructed by the operation start buttons 60.

Moreover, it is more preferable that, as the operation start buttons 60 become capable of instructing the object to be driven 50 (the control device 20) to rotate faster, the display control unit 66 display those buttons on the display screen 52 such that the buttons become larger (wider or longer). In accordance with this feature, it becomes easier for the operator to understand the speed of rotation of the object to be driven 50 that can be instructed by the operation start buttons 60.

### (Exemplary Modification 7)

A plurality of the operation start buttons 60 may be displayed corresponding to a plurality of speeds of rotation of the object to be driven 50. In accordance with this feature, the operator is capable of selecting the speed of rotation of the object to be driven 50 from among a plurality of speeds of rotation.

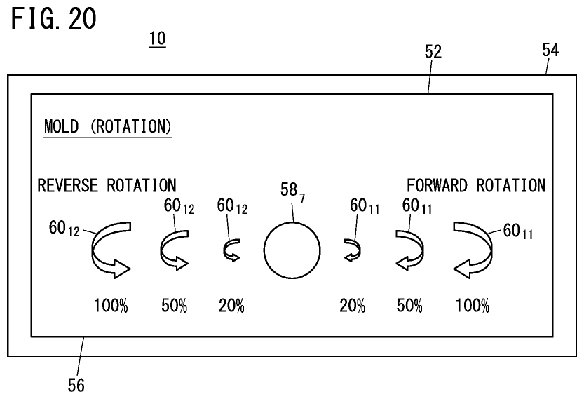

The present exemplary modification is more useful when combined with the aforementioned Exemplary Modification 6. Such a feature will be described with reference to FIG. 20.

FIG. 20 is a diagram illustrating the display screen 52 of the operation panel 10 according to Exemplary Modification 7.

On the display screen 52 shown in FIG. 20, the mold button 58₇, three of the forward rotation buttons 60₁₁, and three of the reverse rotation buttons 60₁₂ are displayed. Moreover, it should be noted that each of the number of the forward rotation buttons 60₁₁ and the number of the reverse rotation buttons 60₁₂ shown in FIG. 20 is not limited to three.

The three forward rotation buttons 60₁₁ instruct that the mold 14 be rotated at mutually different speeds of rotation. Similarly, the three reverse rotation buttons 60₁₂ instruct that the mold 14 be rotated at mutually different speeds of rotation. In this case, in the case of instructing forward rotation of the mold 14, and in the case of instructing reverse rotation of the mold 14, respectively, the operator is capable of selecting the speed of rotation of the mold 14 from among three different speeds of rotation.

A more preferable situation results when the present modification is combined with the Exemplary Modification 6. More specifically, in the example illustrated in FIG. 20, as the forward rotation buttons 60₁₁ instruct the object to be driven 50 (the control device 20) to be rotated at faster speeds of rotation, the forward rotation buttons 60₁₁ are displayed at positions farther away from the mold button 58₇. Similarly, as illustrated in FIG. 20, as the reverse rotation buttons 60₁₂ instruct the object to be driven 50 (the control device 20) to be rotated at faster speeds of rotation, the reverse rotation buttons 60₁₂ are displayed at positions farther away from the mold button 58₇. In accordance with this feature, for example, it becomes easy for the operator to intuitively understand which of the forward rotation buttons 60₁₁ from among the three forward rotation buttons 60₁₁ is the button for the purpose of instructing the object to be driven 50 (the control device 20) to undergo rotation at the fastest speed.

Moreover, it should be noted that the present exemplary modification can be applied to a case of operating an object to be driven 50 that is capable of being operated at a plurality of speeds of rotation. Accordingly, the present exemplary modification is not limited only to a case in which the rotational action of the mold 14 is operated. Further, according to the present exemplary modification, for purposes of illustration, the speed of rotation of the mold 14 is divided into three cases of 20%, 50%, and 100% of a maximum allowable speed. However, the classification of the speeds of rotation of the mold 14 is not limited to this example.

### (Exemplary Modification 8)

The above-described respective exemplary modifications may be appropriately combined within a range in which no technical inconsistencies occur.

Moreover, the present invention is not limited to the above-described embodiment and modifications, and it goes without saying that various additional or modified configurations could be adopted therein without departing from the essence and gist of the present invention.

### Inventions that can be Obtained from the Embodiment

The inventions that can be grasped from the above-described embodiment and the modifications thereof will be described below.

The operation panel (10) for the injection molding machine (12) includes the display unit (54) including the display screen (52), and which displays on the display screen (52) the target selection button (58) by which the object to be driven (50) of the injection molding machine (12) is selected, and the operation start button (60) that initiates the operation of the object to be driven (50), the touch panel (56) provided on the display screen (52), and that detects the touch position of the operator on the display screen (52), and the operation recognition unit (68) which, in the case that the operation start button (60) is touched in a state in which the target selection button (58) is touched and such a touch thereon is maintained, recognizes that an instruction has been issued to initiate the operation of the object to be driven (50) that has been selected by the target selection button (58).

In accordance with such features, the operation panel (10) for the injection molding machine (12) is provided which is capable of reducing any concern over unintentional action of the object to be driven (50).

In the case that the touch position is slid after the target selection button (58) has been touched and in a state in which such a touch thereon is continued, the operation start button (60) is touched, the operation recognition unit (68) may recognize that an instruction has been issued to initiate the operation of the object to be driven (50) that has been selected by the target selection button (58). In accordance with this feature, for example, in the case that the operator inadvertently touches the target selection button (58) or the operation start button (60), it is possible to reduce any concern that the object to be driven (50) will unintentionally start operating.

In the case that the touch position, which is slid from the target selection button (58), has reached the operation start button (60), the operation recognition unit (68) may recognize that an instruction has been issued to initiate the operation of the object to be driven (50) that has been selected by the target selection button (58). In accordance with this feature, for example, in the case that the operator inadvertently touches the target selection button (58) or the operation start button (60), it is possible to reduce any concern that the object to be driven (50) will unintentionally start operating. Further, with a simple operation using one finger, the operator can complete the operation from selecting the object to be driven (50) until initiating the motion of the selected object to be driven (50). Further, in such a case, in the case that touching of the operation start button (60) is released after having recognized that an instruction has been issued to initiate the operation of the object to be driven (50), the operation recognition unit (68) may recognize that an instruction has been issued to stop the operation of the object to be driven (50). In accordance with this feature, with a simple operation using one finger, the operator can complete the selection of the object to be driven (50), the instruction to start the operation of the selected object to be driven (50), and the instruction to stop the operation of the object to be driven (50).

In the case that touching of either one of the target selection button (58) and the operation start button (60) is released after having recognized that an instruction has been issued to initiate the operation of the object to be driven (50), the operation recognition unit (68) may recognize that an instruction has been issued to stop the operation of the object to be driven (50). In accordance with this feature, the operator is capable of easily and quickly stopping the operation of the object to be driven (50).

In the case that both of touching of the target selection button (58) and touching of the operation start button (60) are released after having recognized that an instruction has been issued to initiate the operation of the object to be driven (50), the operation recognition unit (68) may recognize that an instruction has been issued to stop the operation of the object to be driven (50). In accordance with this feature, any concern that the object to be driven (50) may stop moving contrary to the intentions of the operator can be reduced. Further, for example, in the case that the touch panel (56) is not working properly, any concern that the operation recognition unit (68) may erroneously recognize that stopping of the operation has been instructed despite the operator continuing to perform touching can be reduced.

The object to be driven (50) may be capable of moving, and the operation start button (60) may be a button for initiating movement of the object to be driven (50). In accordance with this feature, the operator, using the operation panel (10), is capable of issuing an instruction to initiate movement, to the object to be driven (50) that moves.

The display unit (54) may display the target selection button (58) and the operation start button (60) in a manner so that the direction from the displayed position of the target selection button (58) toward the displayed position of the operation start button (60) coincides with the direction of movement of the object to be driven (50). In accordance with this feature, it is possible to provide a UI that makes it easy for the operator to intuitively understand the direction of movement of the object to be driven (50) that can be instructed.

The object to be driven (50) may be capable of moving in a plurality of directions of movement. A plurality of the operation start buttons (60) may be provided corresponding respectively to the plurality of directions of movement of the object to be driven (50). The display unit (54) may display the target selection button (58) and the plurality of operation start buttons (60) in a manner so that the directions from the displayed position of the target selection button (58) toward the displayed positions of the plurality of operation start buttons (60) coincide with the respective directions of movement in which the object to be driven (50) moves by operating the operation start buttons (60). In accordance with this feature, it is possible to provide a UI that makes it easy for the operator to intuitively understand the direction of movement of the object to be driven (50) that can be instructed.

The plurality of operation start buttons (60) may be provided corresponding respectively to the plurality of movement speeds of the object to be driven (50) in the direction of movement of the object to be driven (50), and the display unit (54) may display the target selection button (58) and the plurality of operation start buttons (60) in a manner so that the distances from the displayed position of the target selection button (58) to the displayed positions of the operation start buttons (60) become longer as the movement speeds at which the object to be driven (50) moves by operating the operation start buttons (60) become faster. In accordance with such features, it is possible to provide a UI that makes it easy for the operator to intuitively understand the speed of movement in each of the directions of movement, of the object to be driven (50) that can be instructed.

The plurality of operation start buttons (60) may be provided corresponding respectively to the plurality of movement speeds of the object to be driven (50), and the display unit (54) may display the target selection button (58) and the operation start buttons (60) in a manner so that the distances from the displayed position of the target selection button (58) to the displayed positions of the operation start buttons (60) become longer as the movement speeds at which the object to be driven (50) moves by operating the operation start buttons (60) become faster. In accordance with such features, it is possible to provide a UI that makes it easy for the operator to intuitively understand the speed of movement of the object to be driven (50) that can be instructed.

The object to be driven (50) may be capable of rotating, and the operation start button (60) may be a button for initiating rotation of the object to be driven (50). In accordance with this feature, the operator, using the operation panel (10), is capable of issuing an instruction to initiate rotation, to the object to be driven (50) that rotates.

At least two of the operation start buttons (60) may be provided corresponding respectively to a forward direction of rotation of the object to be driven (50) and a reverse direction of rotation that is opposite to the forward direction of rotation thereof. The display unit (54) may display the target selection button (58) and the at least two of the operation start buttons (60) in a manner so that the direction from the displayed position of the target selection button (58) toward the displayed position of the operation start button (60) that causes the object to be driven (50) to be rotated in the forward direction, and the direction from the displayed position of the target selection button (58) toward the displayed position of the operation start button (60) that causes the object to be driven (50) to be rotated in the reverse direction are opposite to each other. In accordance with such features, it is possible to provide a UI that makes it easy for the operator to intuitively understand the directions of rotation of the object to be driven (50) that can be instructed.

The plurality of operation start buttons (60) may be provided corresponding respectively to the plurality of speeds of rotation in the directions of rotation of the object to be driven (50), and the display unit (54) may display the target selection button (58) and the operation start buttons (60) in a manner so that the distances from the displayed position of the target selection button (58) to the displayed positions of the operation start buttons (60) become longer as the speeds of rotation at which the object to be driven (50) rotates by operating the operation start buttons (60) become faster. In accordance with such features, it is possible to provide a UI that makes it easy for the operator to intuitively understand the speed of rotation in each of the directions of rotation of the object to be driven (50) that can be instructed.

The plurality of operation start buttons (60) may be provided corresponding respectively to the plurality of speeds of rotation of the object to be driven (50), and the display unit (54) may display the target selection button (58) and the operation start buttons (60) in a manner so that the distances from the displayed position of the target selection button (58) to the displayed positions of the operation start buttons (60) become longer as the speeds of rotation at which the object to be driven (50) rotates by operating the operation start buttons (60) become faster. In accordance with such features, it is possible to provide a UI that makes it easy for the operator to intuitively understand the speed of rotation of the object to be driven (50) that can be instructed.

1. An operation panel for an injection molding machine, the operation panel comprising:
a display unit including a display screen, and configured to display on the display screen a target selection button configured to select an object to be driven of the injection molding machine, and an operation start button configured to initiate an operation of the object to be driven;
a touch panel provided on the display screen, and configured to detect a touch position of an operator on the display screen; and
an operation recognition unit configured to, in a case that the operation start button is touched in a state in which the target selection button is touched and touching of the target selection button is maintained, recognize that an instruction has been issued to initiate the operation of the object to be driven that has been selected by the target selection button.

2. The operation panel for the injection molding machine according to claim 1, wherein, in a case that the touch position is slid after the target selection button has been touched and in a state in which touching thereof is continued, the operation start button is touched, the operation recognition unit recognizes that an instruction has been issued to initiate the operation of the object to be driven that has been selected by the target selection button.

3. The operation panel for the injection molding machine according to claim 2, wherein, in a case that the touch position is slid from the target selection button and then has reached the operation start button, the operation recognition unit recognizes that an instruction has been issued to initiate the operation of the object to be driven that has been selected by the target selection button.

4. The operation panel for the injection molding machine according to claim 1, wherein, in a case that touching of either one of the target selection button and the operation start button is released after having recognized that an instruction has been issued to initiate the operation of the object to be driven, the operation recognition unit recognizes that an instruction has been issued to stop the operation of the object to be driven.

5. The operation panel for the injection molding machine according to claim 1, wherein, in a case that both of touching of the target selection button and touching of the operation start button are released after having recognized that an instruction has been issued to initiate the operation of the object to be driven, the operation recognition unit recognizes that an instruction has been issued to stop the operation of the object to be driven.

6. The operation panel for the injection molding machine according to claim 3, wherein, in a case that touching of the operation start button is released after having recognized that an instruction has been issued to initiate the operation of the object to be driven, the operation recognition unit recognizes that an instruction has been issued to stop the operation of the object to be driven.

7. The operation panel for the injection molding machine according to claim 1, wherein:
the object to be driven is movable; and
the operation start button is a button that is used to initiate movement of the object to be driven.

8. The operation panel for the injection molding machine according to claim 7, wherein the display unit displays the target selection button and the operation start button in a manner so that a direction from a displayed position of the target selection button toward a displayed position of the operation start button coincides with a direction of movement of the object to be driven.

9. The operation panel for the injection molding machine according to claim 8, wherein:
the object to be driven is movable in a plurality of directions of movement;
the operation start button comprises a plurality of operation start buttons that are provided corresponding respectively to the plurality of directions of movement of the object to be driven; and
the display unit displays the target selection button and the plurality of operation start buttons in a manner so that directions from the displayed position of the target selection button toward displayed positions of the plurality of operation start buttons coincide respectively with the directions of movement in which the object to be driven moves by operating the operation start buttons.

10. The operation panel for the injection molding machine according to claim 8, wherein:
the operation start button comprises a plurality of operation start buttons that are provided corresponding respectively to a plurality of movement speeds of the object to be driven in the direction of movement of the object to be driven; and
the display unit displays the target selection button and the plurality of operation start buttons in a manner so that distances from the displayed position of the target selection button to displayed positions of the operation start buttons become longer as the movement speeds at which the object to be driven moves by operating the operation start buttons become faster.

11. The operation panel for the injection molding machine according to claim 7, wherein:
the operation start button comprises a plurality of operation start buttons that are provided corresponding respectively to a plurality of movement speeds of the object to be driven; and
the display unit displays the target selection button and the operation start buttons in a manner so that distances from a displayed position of the target selection button to displayed positions of the operation start buttons become longer as the movement speeds at which the object to be driven moves by operating the operation start buttons become faster.

12. The operation panel for the injection molding machine according to claim 1, wherein:
the object to be driven is rotatable; and
the operation start button is a button that is used to initiate rotation of the object to be driven.

13. The operation panel for the injection molding machine according to claim 12, wherein:
the operation start button comprises at least two of operation start buttons that are provided corresponding respectively to a forward direction of rotation of the object to be driven and a reverse direction of rotation that is opposite to the forward direction of rotation thereof; and
the display unit displays the target selection button and the at least two of operation start buttons in a manner so that a direction from a displayed position of the target selection button toward a displayed position of the operation start button that causes the object to be driven to be rotated in the forward direction, and a direction from the displayed position of the target selection button toward a displayed position of the operation start button that causes the object to be driven to be rotated in the reverse direction are opposite to each other.

14. The operation panel for the injection molding machine according to claim 13, wherein:
the operation start button comprises a plurality of operation start buttons that are provided corresponding respectively to a plurality of speeds of rotation in the directions of rotation of the object to be driven; and
the display unit displays the target selection button and the operation start buttons in a manner so that distances from the displayed position of the target selection button to displayed positions of the operation start buttons become longer as the speeds of rotation at which the object to be driven rotates by operating the operation start buttons become faster.

15. The operation panel for the injection molding machine according to claim 12, wherein:
the operation start button comprises a plurality of operation start buttons that are provided corresponding respectively to a plurality of speeds of rotation of the object to be driven; and
the display unit displays the target selection button and the operation start buttons in a manner so that distances from a displayed position of the target selection button to displayed positions of the operation start buttons become longer as the speeds of rotation at which the object to be driven rotates by operating the operation start buttons become faster.
